(19) United States
(12) Patent Application Publication
(10) Pub. No.: US 2026/0057227 A1
(43) Pub. Date: Feb. 26, 2026

(54) NEURAL NETWORK OPERATIONS BASED ON SPARSE ACTIVATIONS

(71) Applicant: APPLE INC., Cupertino, CA (US)

(72) Inventor: Paolo DI FEBBO, Sunnyvale, CA (US)

(73) Assignee: APPLE INC., Cupertino, CA (US)

(21) Appl. No.: 18/813,791

(22) Filed: Aug. 23, 2024

(51) Int. Cl. G06N 3/065; G06N 3/0495

(52) U.S. Cl. CPC G06N 3/065; G06N 3/0495

(57) ABSTRACT

Disclosed herein are systems and methods for exploiting activation sparsity in a neural network. For example, metadata associated with at least one of a first portion or a second portion of an activation map generated by a layer of a neural network engine is retrieved. The first portion includes at least one non-zero value and the second portion includes all zero values. The first portion and a first set of kernel coefficients corresponding to the at least one non-zero value of the first portion are retrieved based on the metadata. Retrieval of the second portion and a second set of kernel coefficients corresponding to the all zero values of the second portion is bypassed based on the metadata. A convolution operation is performed by the neural network engine based on the first portion and the first set of kernel coefficients.

### BACKGROUND

An artificial neural network (ANN) is a computing system or model that uses a collection of connected nodes (or “neurons”) to process input data. The ANN can be organized into layers where different layers perform different types of transformations on their input. Extensions or variants of ANN include convolution neural networks (CNNs), recurrent neural networks (RNNs), and deep belief networks (DBNs). Such neural networks involve extensive computing operations including multiplication and accumulation. For example, CNNs are a class of machine learning that can use convolution between input data and kernel data. The convolution can be decomposed into multiplication and accumulation operations.

ANNs may be utilized to implement various computation models, such as a large language model (LLM). LLMs are designed to mimic human language processing capabilities, including language understanding and generation. LLMs are widely used for natural language processing (NLP) tasks, such as text classification, question answering, and language translation. The training and inference of these models require a significant amount of computing power and energy consumption.

### SUMMARY

Various embodiments exploiting activation sparsity in a neural network are disclosed. In some embodiments, a method includes retrieving metadata associated with at least one of a first portion or a second portion of an activation map generated by a layer of a neural network engine. The first portion includes at least one non-zero value and the second portion includes all zero values. The method also includes retrieving, based on the metadata, the first portion and a first set of kernel coefficients corresponding to the at least one non-zero value of the first portion, bypassing, based on the metadata, retrieval of the second portion and a second set of kernel coefficients corresponding to the all zero values of the second portion, and performing, by the neural network engine, a convolution operation based on the first portion and the first set of kernel coefficients.

In some embodiments, a system includes system memory and a neural processor. The neural processor is configured to retrieve metadata associated with at least one of a first portion or a second portion of an activation map generated by a layer of a neural network engine. The first portion least one non-zero value and the second portion includes all zero values. The neural processor is also configured to retrieve, based on the metadata, the first portion and a first set of kernel coefficients corresponding to the at least one non-zero value of the first portion, bypass, based on the metadata, retrieval of the second portion and a second set of kernel coefficients corresponding to the all zero values of the second portion, and perform, by the neural network engine, a convolution operation based on the first portion and the first set of kernel coefficients.

In some embodiments, a non-transitory computer readable medium having instructions stored thereon that, when executed by at least one processor, cause the at least one processor to perform operations. The operations include retrieving metadata associated with at least one of a first portion or a second portion of an activation map generated by a layer of a neural network engine. The first portion includes at least one non-zero value and the second portion includes all zero values. The method also includes retrieving, based on the metadata, the first portion and a first set of kernel coefficients corresponding to the at least one non-zero value of the first portion, bypassing, based on the metadata, retrieval of the second portion and a second set of kernel coefficients corresponding to the all zero values of the second portion, and performing, by the neural network engine, a convolution operation based on the first portion and the first set of kernel coefficients.

### BRIEF DESCRIPTION OF THE DRAWINGS

The accompanying drawings are incorporated herein and form a part of the specification.

FIG. 1 is a high-level diagram of an electronic device, according to some embodiments.

FIG. 2 is a block diagram illustrating components in the electronic device, according to some embodiments.

FIG. 3 is a block diagram illustrating a neural processor, according to some embodiments.

FIG. 4 is a block diagram of a neural engine of the neural processor, according to some embodiments.

FIG. 5 is a flowchart for a method for performing neural network operations based on sparse activations, according to some embodiments.

FIG. 6 is a flowchart for a method for providing kernel coefficients to a network neural engine, according to some embodiments.

FIG. 7 is a flowchart for a method for storing a kernel matrix into a memory local to a neural network engine, according to some embodiments.

FIG. 8 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

A neural network may be utilized to implement various computation models, including an LLM. Execution of an LLM involves compute intensive tasks, such as matrix multiplication operations and activation functions. Such operations and functions consume many processing cycles and memory. In some instances, the activation maps resulting from such functions may include more zero values than non-zero values. Consequently, non-zero activation values may be sparse in such activation maps. In some embodiments, the sparsity in non-zero values may be exploited to improve the computing efficiency of a neural network.

For instance, provided herein are a system, apparatus, device, method and/or computer program product embodiments, and/or combinations and sub-combinations thereof, for exploiting activation sparsity in a neural network. For example, metadata associated with at least one of a first portion or a second portion of an activation map generated by a layer of a neural network engine is retrieved. The first portion includes at least one non-zero value and the second portion includes all zero values. The first portion and a first set of kernel coefficients corresponding to the at least one non-zero value of the first portion are retrieved based on the metadata. Retrieval of the second portion and a second set of kernel coefficients corresponding to the all zero values of the second portion is bypassed based on the metadata. A convolution operation is performed by the neural network engine based on the first portion and the first set of kernel coefficients.

The techniques described herein improve the functioning of a computing system on which the neural network executes. For example, because the portions of an activation map that include all zero values are discarded, memory that stores such data is conserved. Moreover, kernel coefficients for such portions of the activation map are not retrieved from memory, thereby reducing the number of read operations to the memory. Accordingly, various compute resources (e.g., processor cycles, memory, storage, etc.) are conserved during execution of the neural network as a result of exploiting activating sparsity.

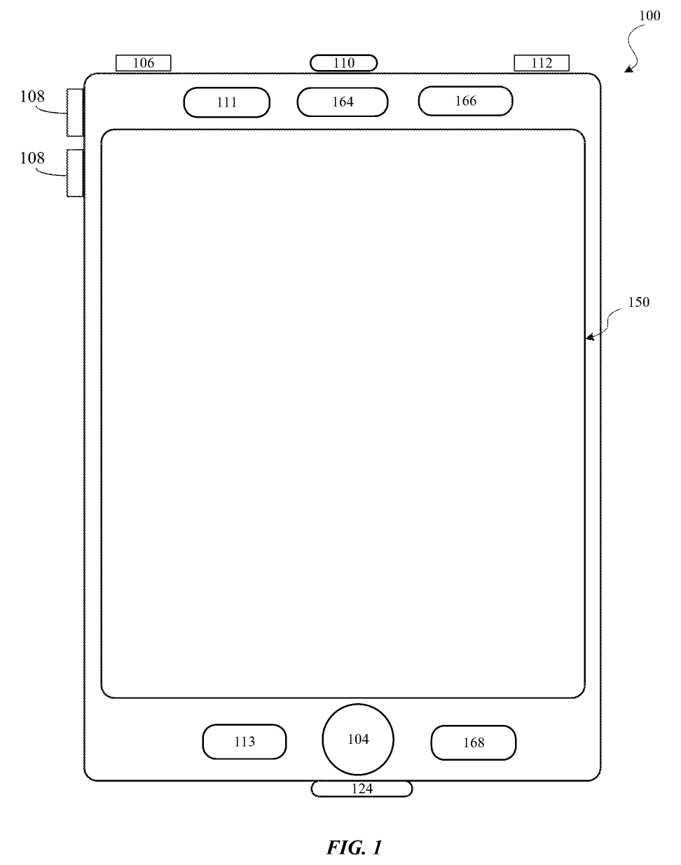

Embodiments of electronic devices, user interfaces for such devices, and associated processes for using such devices are described. In some embodiments, the device is a portable communications device, such as a mobile telephone, that also contains other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, laptops or tablet computers, are optionally used. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). An example electronic device described below in conjunction with FIG. 1 (e.g., device 100) may include a touch-sensitive surface for receiving user input. The electronic device may also include one or more other physical user-interface devices, such as a physical keyboard, a mouse and/or a joystick.

FIG. 1 is a high-level diagram of an electronic device 100, according to some embodiments. Device 100 may include one or more physical buttons, such as a “home” or menu button 104. Menu button 104 is, for example, used to navigate to any application in a set of applications that are executed on device 100. In some embodiments, menu button 104 includes a fingerprint sensor that identifies a fingerprint on menu button 104. The fingerprint sensor may be used to determine whether a finger on menu button 104 has a fingerprint that matches a fingerprint stored for unlocking device 100. Alternatively, in some embodiments, menu button 104 is implemented as a soft key in a graphical user interface (GUI) displayed on a touch screen.

In some embodiments, device 100 includes touch screen 150, menu button 104, push button 106 for powering the device on/off and locking the device, volume adjustment buttons 108, Subscriber Identity Module (SIM) card slot 110, headset jack 112, and docking/charging external port 124. Push button 106 may be used to turn the power on/off on device 100 by depressing button 106 and holding button 106 in the depressed state for a predefined time interval; to lock the device by depressing button 106 and releasing button 106 before the predefined time interval has elapsed; and/or to unlock device 100 or initiate an unlock process. Alternatively, in some embodiments, device 100 also accepts verbal input for activation or deactivation of some functions through microphone 113. Device 100 includes various components including a memory (which may include one or more computer readable storage mediums), a memory controller, one or more central processing units (CPUs), a peripherals interface, an RF circuitry, an audio circuitry, speaker 111, microphone 113, an input/output (I/O) subsystem, and other input or control devices. Device 100 may include one or more image sensors 164, one or more proximity sensors 166, and one or more accelerometers 168. Device 100 may include more than one type of image sensors 164. Each type may include more than one image sensor 164. For example, one type of image sensors 164 may be cameras and another type of image sensors 164 may be infrared sensors for facial recognition that is performed by one or more machine learning models stored in device 100. Device 100 may include components not shown in FIG. 1, such as an ambient light sensor, a dot projector and a flood illuminator that is to support facial recognition.

Device 100 is only one example of an electronic device, and device 100 may have more or fewer components than listed above, some of which may be combined into a component or have a different configuration or arrangement. In some embodiments, device 100 does not have audio/visual components, such as touch screen 150, speaker 111, or image sensors 164. The various components of device 100 listed above are embodied in hardware, software, firmware, or a combination thereof, including one or more signal processing and/or application-specific integrated circuits (ASICs).

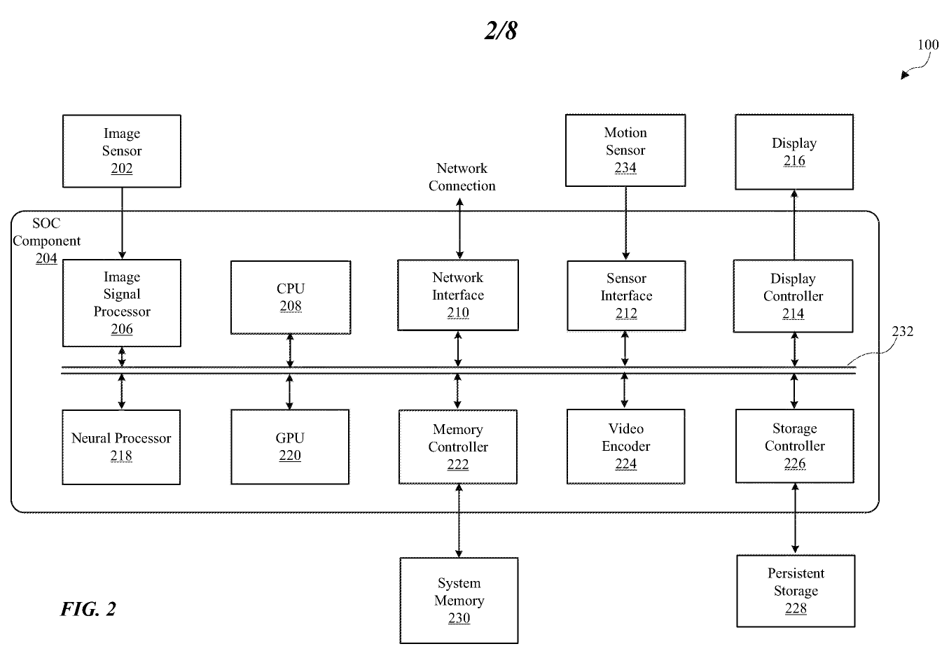

FIG. 2 is a block diagram illustrating components in device 100, according to some embodiments. Device 100 may perform various operations including implementing one or more machine learning models. For this and other purposes, device 100 may include, among other components, image sensors 202, a system-on-a-chip (SOC) component 204, a system memory 230, a persistent storage (e.g., flash memory) 228, a motion sensor 234, and a display 216. The components as illustrated in FIG. 2 are merely illustrative. For example, device 100 may include other components (such as a speaker or a microphone) that are not illustrated in FIG. 2. Further, some components (such as motion sensor 234) may be omitted from device 100.

An image sensor 202 is a component for capturing image data and may include, for example, a complementary metal-oxide-semiconductor (CMOS) active-pixel sensor, a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color filter array (CFA) pattern. It is noted that the raw image data may be in other formats or patterns.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is a component for displaying images as generated by SOC component 204. Display 216 may include, for example, a liquid crystal display (LCD) device or an organic light-emitting diode (OLED) device. Based on data received from SOC component 204, display 116 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may include any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof.

Persistent storage 228 is a component for storing data in a non-volatile manner. Persistent storage 228 retains data even when power is not available. Persistent storage 228 may include read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) (e.g., convolutional network networks (CNNs), recurrent network networks (RNNs), autoencoders, and long short term memory (LSTM)-based neural networks). A machine learning model may be an independent model that works with a neural processor 218 and various software applications or sensors of device 100. A machine learning model may also be part of a software application. The machine learning models may perform various tasks, such as facial recognition, image classification, video classification, object, concept and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results during runtime using the models. For example, device 100 captures facial images of the user and uses the images to continue to improve a machine learning model that is used to lock or unlock the device 100.

SOC component 204 may include one or more integrated circuit (IC) chips and performs various data processing processes. SOC component 204 may include, among other subcomponents, image signal processor (ISP) 206, a central processor unit (CPU) 208, a network interface 210, sensor interface 212, display controller 214, neural processor 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 may be implemented by processing logic that can include hardware (e.g., circuitry, dedicated logic, programmable logic, microcode, etc.), software (e.g., instructions executing on a processing device), or a combination thereof. ISP 206 may perform various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations.

CPU 208 may include any suitable instruction set architecture, and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may implement the same ISA.

Graphics processing unit (GPU) 220 may include graphics processing circuitry for performing various operations, including graphics and video rendering. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

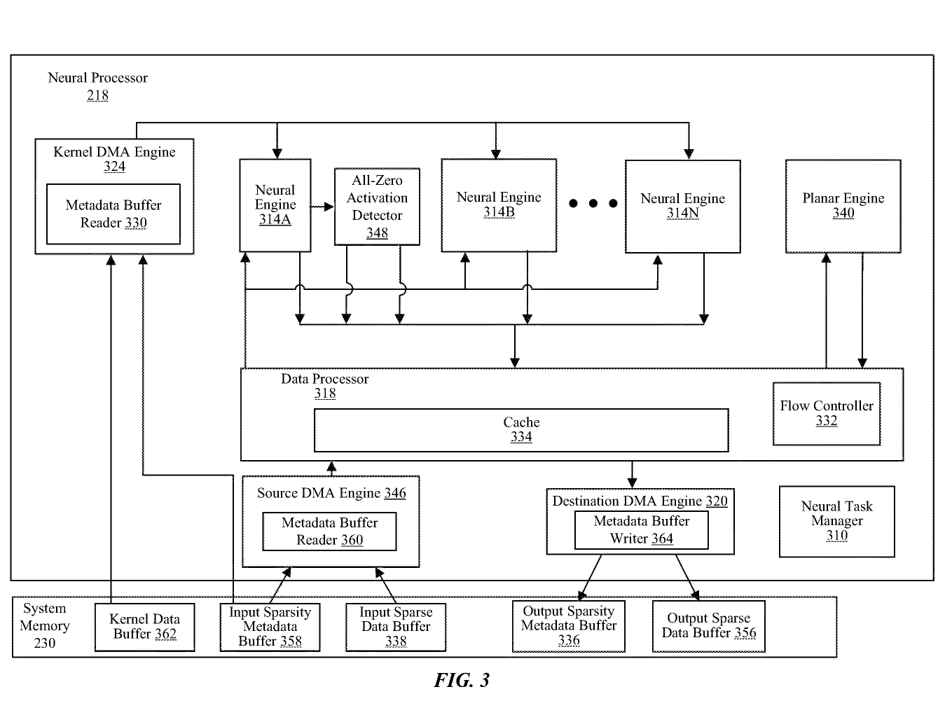

Neural processor 218 may be implemented by processing logic that can include hardware (e.g., circuitry, dedicated logic, programmable logic, microcode, etc.), software (e.g., instructions executing on a processing device), or a combination thereof. Neural processor 218 may perform various machine learning operations based on computation including multiplication, addition, and accumulation. Such computation may be arranged to perform, for example, various types of tensor multiplications, such as tensor product and convolution of input data and kernel data (e.g., weights). Neural processor 218 may be configurable and may perform these operations in a fast and power-efficient manner while relieving CPU 208 of resource-intensive operations associated with neural network operations. Neural processor 218 may receive the input data from sensor interface 212, image signal processor 206, persistent storage 228, system memory 230 or other sources (e.g., network interface 210 or GPU 220). The output of neural processor 218 may be provided to various components of device 100, such as image signal processor 206, system memory 230 or CPU 208 for various operations. In some embodiments, neural processor 218 is implemented as a standalone processing unit on a device, such as device 100. In some embodiments, neural processor 218 is one of a plurality of neural processors 218 connected by bus 232. The structure and operation of neural processor 218 are described below in detail with reference to FIG. 3.

Network interface 210 is a subcomponent that enables data to be exchanged between devices 100 and other devices via one or more networks (e.g., carrier or agent devices). For example, audio, video, or other image data may be received from other devices via network interface 210 and be stored in system memory 230 for subsequent processing (e.g., via a back-end interface to image signal processor 206) and display. The networks may include Local Area Networks (LANs) (e.g., an Ethernet or corporate network) and Wide Area Networks (WANs). The image data received via network interface 210 may undergo image processing processes by ISP 206.

Sensor interface 212 may be implemented by processing logic that can include hardware (e.g., circuitry, dedicated logic, programmable logic, microcode, etc.), software (e.g., instructions executing on a processing device), or a combination thereof. Sensor interface 212 interfaces with motion sensor 234. Sensor interface 212 receives sensor information from motion sensor 234 and processes the sensor information to determine the orientation or movement of device 100.

Display controller 214 may be implemented by processing logic that can include hardware (e.g., circuitry, dedicated logic, programmable logic, microcode, etc.), software (e.g., instructions executing on a processing device), or a combination thereof. Display controller 214 may provide video or image data to display 216 for display thereby. Display controller 214 may receive the video or image data from ISP 206, CPU 208, GPU 220, or system memory 230 and may process the video or image data into a format suitable for display on display 216.

Memory controller 222 may be implemented by processing logic that can include hardware (e.g., circuitry, dedicated logic, programmable logic, microcode, etc.), software (e.g., instructions executing on a processing device), or a combination thereof. Memory controller 222 may communicate with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 may be implemented by processing logic that can include hardware (e.g., circuitry, dedicated logic, programmable logic, microcode, etc.), software (e.g., instructions executing on a processing device), or a combination thereof. Video encoder 223 may encode video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor 218, ISP 206, CPU 208 or GPU 220. Such software components may be stored in system memory 230, persistent storage 228 or another device communicating with device 100 via network interface 210.

Neural processor 218 may be configured to perform machine learning operations on the input data of neural processor 218. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as “hidden layers.” Each layer may include one or more nodes (or neurons), which may be fully or partially connected to other nodes in adjacent layers. During forward propagation, the neural network performs computation in the forward direction based on outputs of a preceding layer. The operation of a node may be defined by one or more functions. The functions that define the operation of a node may include various computation operations, such as convolution of data with one or more kernels, pooling of layers, tensor multiplication, etc. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Common activation functions may include step functions, linear functions, sigmoid functions, hyperbolic tangent functions (tanh), and rectified linear unit (ReLU) functions. After a batch of data of training samples passes through a neural network in the forward propagation, the results may be compared to the training labels of the training samples to compute the network’s loss function, which represents the performance of the network. In turn, the neural network performs backpropagation by using coordinate descent, such as stochastic coordinate descent (SGD), to adjust the coefficients in various functions to improve the value of the loss function.

During training, device 100 may use neural processor 218 to perform all or some of the operations in the forward propagation and backpropagation. Multiple rounds of forward propagation and backpropagation may be performed by neural processor 218, solely or in coordination with other processors, such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

During prediction or inference, device 100 may receive one or more input samples. Neural processor 218 may take the input samples to perform forward propagation to determine one or more results. The input samples may be images, speeches, text files, sensor data, video data, audio data, or other data.

Data and functions (e.g., input data, kernels, functions, layer outputs, gradient data, etc.) in machine learning may be saved and represented by one or more tensors. Common operations related to training and runtime of a machine learning model may include tensor product, tensor transpose, tensor elementwise operation, convolution, application of an activation function, automatic differentiation to determine gradient, statistics and aggregation of values in tensors (e.g., average, variance, standard deviation), tensor rank and size manipulation, etc.

While the training and runtime of a neural network is discussed as an example, the neural processor 218 may also be used for the operations of other types of machine learning models, such as a kernel support vector machine (SVM) model.

Referring to FIG. 3, an example neural processor 218 may include, among other components, a neural task manager 310, neural network engines 314A through 314N (hereinafter collectively referred as “neural engines 314” and individually also referred to as “neural engine 314”), a kernel direct memory access (DMA) engine 324, a data processor 318, a destination DMA engine 320, a source DMA engine 356, a planar engine 340, and an all-zero activation detector 348. Neural processor 218 may include fewer or additional components not illustrated in FIG. 3.

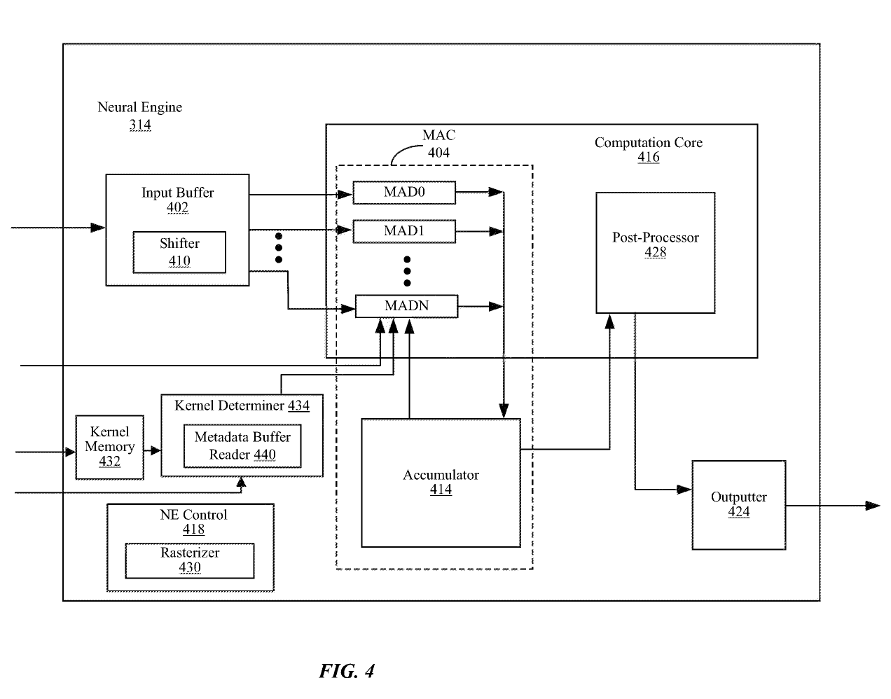

Each of neural engines 314 performs computing operations for machine learning in parallel. Depending on the load of operation, the entire set of neural engines 314 may be operating or only a subset of neural engines 314 may be operating while the remaining neural engines 314 are placed in a power-saving mode to conserve power. Each of neural engines 314 includes components for storing one or more kernels, for performing multiply-accumulate operations, activation functions, and for post-processing to generate output data, as described below in detail with reference to FIG. 4. Neural engines 314 may specialize in performing computationally heavy operations, such as matrix multiplication operations, convolution operations, and tensor product operations. Convolution operations may include different kinds of convolutions, such as cross-channel convolutions (e.g., a convolution that accumulates values from different channels), channel-wise convolutions, and transposed convolutions.

Planar engine 340 may specialize in performing simpler computing operations, where speed may primarily depend on the input and output (I/O) speed of the data transmission instead of the computation speed within planar engine 340. Those computing operations may be referred to as “I/O bound computations.” In contrast, neural engines 314 may focus on complex computations, where speed may primarily depend on the computation speed within each neural engine 314. For example, planar engine 340 is efficient at performing operations within a single channel while neural engines 314 are efficient at performing operations across multiple channels that may involve heavy accumulation of data. The use of neural engine 314 to compute I/O bound computations may not be efficient in terms of both speed and power consumption. In some embodiments, input data may be a tensor whose rank is larger than three (e.g., having three or more dimensions). A set of dimensions (two or more) in the tensor may be referred to as a “plane,” while another dimension may be referred to as a “channel.” Neural engines 314 may convolve data of a plane in the tensor with a kernel and accumulate results of the convolution of different planes across different channels. On the other hand, planar engine 340 may specialize in operations within the plane.

Planar engine 340 may be programmed for operation in one of multiple modes, including a pooling mode, an elementwise mode, and a reduction mode. In the pooling mode, planar engine 340 reduces a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar).

Neural task manager 310 manages the overall operation of neural processor 218. Neural task manager 310 may receive a task list from a compiler executed by CPU 208, store tasks in its task queues, choose a task to perform, and send task commands to other components of neural processor 218 for performing the chosen task. Data may be associated with a task command that indicates the types of operations to be performed on the data. Data of neural processor 218 includes input data that is transmitted from another source, such as system memory 230, and data generated by neural processor 218 in a previous operation cycle. Each dataset may be associated with a task command that specifies the type of operations to be performed on the data. Neural task manager 310 may also perform switching of tasks on detection of events, such as receiving instructions from CPU 208. In some embodiments, neural task manager 310 sends rasterizer information to the components of neural processor 218 to enable each of the components to track, retrieve, or process appropriate segments of the input data and kernel data. For example, neural task manager 310 may include registers that stores the information regarding the size and rank of a dataset for processing by neural processor 218.

For instance, input data may be split into smaller pieces of data for parallel processing at multiple neural engines 314 and planar engine 340. In some embodiments, a set of data used for a convolution operation may be a subset of data from a token. A set of data used for a convolution operation may be referred to as a “convolution group,” which can be split into multiple smaller units. The hierarchy of smaller units (segments) may be convolution groups, slices, tiles, work units (WUs), output channel groups, input channels (Cin), sub-Cins for input stride, etc. For example, a convolution group may be split into several slices; a slice may be split into several tiles; a tile may be split into several work units; and so forth. In the context of neural engine 314, a work unit may be a segment of the input data, such as data processed by planar engine 340 or data processed in a prior cycle of neural engines 314, having a size suitable for an accumulator (e.g., accumulator 414, as shown in FIG. 4) of neural engines 314. In one case, the size of each work unit is 256 bytes. In such embodiments, work units can be shaped to one of 16 x 16, 32 x 8, 64 x 4, 128 x 2 or 256 x 1 datasets.

In an example in which an image is input to neural engines 314, the image may be represented as a multi-dimensional matrix, where each dimension includes one or more segments (e.g., work units) of the input data. In an example, a first dimension corresponds to the width (w) of the image, a second dimension corresponds to the height (h) of the image, and a third dimension corresponds to a depth or color channel (c) of the image (e.g., a red channel, a blue channel, or a green channel for a red, green, blue (RGB) image). It is noted that this is merely one example of a channel and that input data can have any number of channels depending on the features extracted from the input data.

In the context of planar engine 340, a work unit may be (i) a segment of input data, (ii) data from neural engine 314, or (iii) data from a prior cycle of planar engine 340 that can be processed simultaneously at planar engine 340. Although neural task manager 310 is illustrated in FIG. 3 as part of neural processor 218, neural task manager 310 may be a component outside neural processor 218.

Kernel DMA engine 324 may be implemented by processing logic that can include hardware (e.g., circuitry, dedicated logic, programmable logic, microcode, etc.), software (e.g., instructions executing on a processing device), or a combination thereof. Kernel DMA engine 324 may be configured to fetch kernel data (e.g., kernel coefficients) from a source (e.g., system memory 230) and sends kernel coefficients to each of neural engines 314. The kernel coefficients may be stored in a kernel matrix, which is stored in a kernel data buffer 362. Kernel data buffer 362 may be a portion of system memory 230 that is allocated and configured to store the kernel matrix. Kernel data represents information from which kernel elements can be extracted. In some embodiments, the kernel data may be in a compressed format, which is decompressed at each of neural engines 314. Although kernel data provided to each of neural engines 314 may be the same in some instances, the kernel data provided to each of neural engines 314 is different in most instances. In some embodiments, the direct memory access nature of kernel DMA engine 324 may allow kernel DMA engine 324 to fetch and write data directly from the source without the involvement of CPU 208.

Data processor 318 may be implemented by processing logic that can include hardware (e.g., circuitry, dedicated logic, programmable logic, microcode, etc.), software (e.g., instructions executing on a processing device), or a combination thereof. Data processor 318 may be configured to manage data traffic and task performance of neural processor 218. Data processor 318 may include a flow controller 332 and a cache 334. Cache 334 is temporary storage for storing data associated with operations of neural processor 218 and planar engine 340, such as input data that is transmitted to and/or received from system memory 230 (e.g., data from a machine learning model) and other data that is generated within neural processor 218 or planar engine 340. The data stored in cache 334 may include different subsets that are sent to various downstream components, such as neural engines 314 and planar engine 340. In one example, cache 334 may be a level 2 (L2) cache.

In some embodiments, cache 334 includes a non-transitory memory that can be accessed by neural engines 314 and planar engine 340. Cache 334 may store input data for feeding to corresponding neural engines 314A through 314N or planar engine 340, as well as output data from each of neural engines 314A through 314N or planar engine 340 for feeding back into one or more neural engines 314 or planar engine 340, or sending to a target circuit (e.g., system memory 230). Cache 334 may also store input data and output data of planar engine 340 and allow the exchange of data between neural engine 314 and planar engine 340. For example, one or more the output data of neural engines 314 are used as input data to planar engine 340. Likewise, the output of planar engine 340 may be used as input data of neural engines 314. The inputs of neural engines 314 or planar engine 340 may be any data stored in cache 334. For example, in various operating cycles, the source datasets from one of the engines (e.g., neural engines 314 or planar engine 340) fetches as inputs may be different. The input of an engine may be an output of the same engine in previous cycles, outputs of different engines, or any other suitable source datasets stored in buffer memory 334. Also, a dataset in cache 334 may be divided and sent to different engines for different operations in the next operating cycle. Two datasets in cache 334 may also be joined for the next operation. As will be described below, cache 334 may also temporarily store data provided by all-zero activation detector 348 and/or certain data retrieved from system memory 230 by source DMA engine 346.

Flow controller 332 of data processor 318 may be implemented by processing logic that can include hardware (e.g., circuitry, dedicated logic, programmable logic, microcode, etc.), software (e.g., instructions executing on a processing device), or a combination thereof. Flow controller 332 may be configured to control the exchange of data between neural engines 314 and planar engine 340. The operations of data processor 318 and other components of neural processor 218 are coordinated so that the input data and intermediate data stored in data processor 318 may be reused across multiple operations at neural engines 314 and planar engine 340, thereby reducing data transfer to and from system memory 230. Flow controller 332 may perform one or more of the following operations: (i) monitor the size and rank of data (e.g. data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., data processor 318 may operate in a broadcast mode where the same data is fed to multiple input channels of neural engines 314 so that multiple or all neural engines 314 receive the same data or in a unicast mode where different neural engines 314 receive different data), and (iv) transmit a configuration command to the planar engine 340 to direct planar engine 340 to program itself for operating in one of multiple operation modes.

The data of neural processor 218 stored in cache 334 may be part of, among others, image data, histogram of oriented gradients (HOG) data, audio data, metadata, output data of a previous cycle of a neural engine 314, and other processed data received from other components of the SOC component 204.

As described above, neural engines 314 may be configured to perform matrix multiplication operations, for example, when executing a large language model (LLM). Such operations may be performed as a multi-channel 1x1 convolution, where a 1x1 filter including a single weight for each channel. The filter may be applied to an input feature map with a stride of one (e.g. left-to-right and top-to-bottom) resulting in an output feature map (also referred to as an “activation map”) with the same width and height as the input. One or more activation functions may also be applied on the output feature map (e.g., step functions, linear functions, sigmoid functions, tanh functions, and/or ReLU functions). In some instances, the activation maps resulting from such transformations may include more zero values than non-zero values. Consequently, non-zero activation values may be sparse in such activation maps. In some embodiments, all-zero activation detector 348 may be configured to exploit activation sparsity to improve the computing efficiency of neural engines 314.

All-zero activation detector 348 may be implemented by processing logic that can include hardware (e.g., circuitry, dedicated logic, programmable logic, microcode, etc.), software (e.g., instructions executing on a processing device), or a combination thereof. All-zero activation detector 348 may be configured to analyze activation maps generated by neural engines 314 and determine whether any portion (or segment) of the activation maps include all zero values. All-zero activation detector 348 may be configured to analyze each activation map on a segment-by-segment basis (e.g., on a work unit-by-work unit and/or channel-by-channel basis) to determine whether a particular portion includes either all zero values or at least one non-zero value. All-zero activation detector 348 may provide one or more portions of an activation map that include at least one non-zero value (also referred herein as “sparse data.”) to data processor 318. All-zero activation detector 348 does not provide portions of activation maps that include all zero values to data processor 318. Instead, such portions are discarded and not stored in a memory (e.g., cache 334 or system memory 230), thereby conserving memory space.

For activation maps determined to have portion(s) including all zero values, all-zero activation detector 348 may generate metadata to indicate that such activation maps include portion(s) including all zero values. For example, the metadata may include an indication for each portion of a given activation map. In such an example, the indication may indicate either that a particular portion includes all zero values or includes at least one non-zero value. In another example, the metadata may indicate the portions of an activation map that include all zero values. For instance, suppose an activation map includes 10 work units, and all-zero activation detector 348 determines that WUs 1, 5, and 10 include all zero values. The metadata may include one or more indications indicating that WUs 1, 5, and 10 include all zero values and may provide no indications for WUs 2, 3, 4, 6, 7, 8, and 9. Based on the indication(s) included in the metadata, it may be inferred that each of WUs, 2, 3, 4, 6, 7, 8, and 9 include at least one non-zero value. In a further example, the metadata may just indicate the portions of an activation map that include at least one non-zero value. For instance, suppose all-zero activation detector 348 determines what WUs 1, 6, 7, and 9 each includes at least one non-zero value. The metadata may include indication(s) that WUs 1, 6, 7, and 9 include at least one non-zero value, and provide no indications for WUs, 2, 3, 4, 5, 8, and 10. Based on the indication(s) included in the metadata, it may be inferred that each of WUs, 2, 3, 4, 5, 8, and 10 include all zero values. It is noted that the sparsity encoding schemes described above for the metadata are exemplary and that other sparsity encoding schemes for indicating which portions of an activation map include either all zero values or at least one non-zero value may be utilized. The metadata may also indicate the size of a given activation map, where the size is based on the number of portions including at least one non-zero value. As the number of portions including at least one non-zero value may vary between different activation maps, the sizes indicated in the metadata for such activation maps may also vary. It is noted that while FIG. 3 depicts all-zero activation detector 348 as receiving activation maps from neural engine 314A, all-zero activation detector 348 may be configured to receive and analyze activation maps from each of neural engines 314A-314N. Alternatively, each of neural engines 314A-314N may be coupled to a respective all-zero activation detector that receives and analyzes activation maps from just the neural engine coupled thereto.

Data processor 318 may be configured to store sparse data and the metadata in cache 334. Cache 334 may temporarily store sparse data and the metadata. Cache 334 is utilized as an intermediate storage for sparse data and the metadata until the sparse data and the metadata are stored in system memory 230.

Destination DMA engine 320 may be implemented by processing logic that can include hardware (e.g., circuitry, dedicated logic, programmable logic, microcode, etc.), software (e.g., instructions executing on a processing device), or a combination thereof. Destination DMA engine 320 may be configured to retrieve the sparse data and the metadata from cache 334. Destination DMA engine 320 may be configured to write the retrieved sparse data in an output sparse data buffer 356. Destination DMA engine 320 may include may include a metadata buffer writer 364 that is configured to write the retrieved metadata in an output sparsity metadata buffer 336. The sparse data and the metadata are removed from cache 334 upon retrieval from destination DMA engine 320. As shown in FIG. 3, each of output sparse data buffer 356 and output sparsity metadata buffer 336 are stored in system memory 230. Output sparse data buffer 356 may include a first portion of system memory 230 that is allocated and configured to store the sparse data, and output sparsity metadata buffer 336 may include a second portion of system memory 230 (that is different from the first portion of system memory 230) that is allocated and configured to store the metadata. The metadata is stored in output sparsity metadata buffer 336 so that it becomes accessible to kernel DMA engine 324 (e.g., via input sparsity metadata buffer 358, as described below). If the metadata were maintained in cache 334, kernel DMA engine 324 would not be able to access the metadata, as there is no accessible data path between kernel DMA engine 324 and cache 334.

Sparse data may be utilized by another layer of neural engines 314, for example, to perform another matrix multiplication operation. Neural task manager 310 may be configured to determine whether another layer of neural engines 314 requires sparse data for another matrix multiplication operation, for example, based on the task list from the compiler executed by CPU 208. In response to determining that another layer of neural engines 314 requires the sparse data, neural task manager 310 may provide a task command to source DMA engine 346.

Source DMA engine 346 may be implemented by processing logic that can include hardware (e.g., circuitry, dedicated logic, programmable logic, microcode, etc.), software (e.g., instructions executing on a processing device), or a combination thereof. Source DMA engine 346 may include a metadata buffer reader 360 that is configured to retrieve the metadata from input sparsity metadata buffer 358 and determine the size of the sparse data based on the metadata. Source DMA engine 346 retrieves an amount of sparse data corresponding to the determined size of the sparse data from an input sparse data buffer 338 and provides the sparse data to data processor 318. Input sparse data buffer 338 may include a third portion of system memory 230 that is allocated and configured to store the sparse data, and input sparsity metadata buffer 358 may include a fourth portion of system memory 230 (that is different from the third portion of system memory 230) that is allocated and configured to store the metadata. It is noted that when sparse data is utilized in a subsequent layer of neural engines 314, output sparsity data buffer 356 and input sparse buffer 356 may correspond to a same first region of system memory, and that output sparsity metadata buffer 336 and input sparsity metadata buffer 358 may correspond to a same second region of system memory 230. Data processor 318 temporarily stores the sparse data in cache 334. Neural engines 314 may retrieve the sparse data from cache 334 and provide the sparse data to the next layer of neural engines 314. The sparse data is removed from cache 334 upon providing the sparse data to neural engines 314.

Neural task manager 310 may also provide task command to a metadata buffer reader 330 of kernel DMA engine 324. Metadata buffer reader 330 may be implemented by processing logic that can include hardware (e.g., circuitry, dedicated logic, programmable logic, microcode, etc.), software (e.g., instructions executing on a processing device), or a combination thereof. Metadata buffer reader 330, in response to the task command, may be configured to retrieve the metadata from input sparsity metadata buffer 358.

Kernel DMA engine 324 analyzes the metadata retrieved by metadata buffer reader 330 to determine which portion(s) (e.g., WUs) of the activation map generated by neural engine 314 included all zero values and which portion(s) of the activation map included at least one non-zero value based on the sparsity encoding utilized by the metadata, as described above. Kernel DMA engine 324 may be configured to retrieve a set of kernel coefficients mapped to a portion of the activation map that includes at least one non-zero value. Kernel DMA engine 324 may retrieve the set of kernel coefficients from a kernel matrix stored in kernel data buffer 362. The kernel matrix may store coefficients, where each coefficient corresponds to (or is mapped to) a particular value of the activation map. In some embodiments, kernel coefficients have a 1:1 correspondence with a particular value of the activation map. Kernel DMA engine 324 may bypass retrieval of a set of kernel coefficients corresponding to a portion of the activation map that includes all zero values. This advantageously reduces the number of read operations to system memory 230.

The retrieved kernel coefficients are provided, by kernel DMA engine 324, to neural engines 314A-314N, which perform various operations based on the kernel coefficients and the input data, including convolution operations.

In some embodiments, neural task manager 310, based on the task list or a single task itself, may determine that the kernel coefficients in the kernel matrix are to be re-used for a task utilizing multiple layers, for multiple tasks of neural engines 314, and/or for multiple WUs within the same task. In such a case, kernel DMA engine 324 may retrieve the entire kernel matrix from system memory 230 and provide the entire kernel matrix to neural engine(s) 314. Neural engine(s) 314 may store the entire kernel matrix in a local memory. Neural engine(s) 314 may also be configured to retrieve the metadata from sparsity metadata buffer 336 and determine, based on metadata 324, which kernel coefficients of kernel matrix are to be utilized for performing an operation in a similar manner as described above with reference to kernel DMA engine 324. Additional details regarding operations performed by neural engines 314 are provided below with reference to FIG. 4.

FIG. 4 is a block diagram of neural engine 314, according to some embodiments. Neural engine 314 performs various operations to facilitate machine learning, such as convolution (e.g., matrix multiplication), tensor product, and other operations that may involve heavy computations. For this purpose, neural engine 314 receives the input data, performs multiply-accumulate operations (e.g., convolution operations) on the input data based on the stored kernel coefficients received from kernel DMA engine 324, performs further post-processing operations on the result of the multiply-accumulate operations, and generates output data. The input data obtained by neural engine 314 and/or the output data provided by neural engine 314 may be of a single channel or span across multiple channels.

In an example in which a subsequent layer is performing matrix multiplication based on the activation map, as described above, the input data obtained by neural engine 314 may include the sparse data retrieved from input sparse data buffer 338 by source DMA engine 346.

Neural engine 314 may include, among other components, an input buffer 402, a computation core 416, a neural engine (NE) control 418, an accumulator 414, an outputter 424, a kernel memory 432, and a kernel determiner 434. Neural engine 314 may include fewer components than what is illustrated in FIG. 4 or include further components not illustrated in FIG. 4.

Input buffer 402 may be implemented by processing logic that can include hardware (e.g., circuitry, dedicated logic, programmable logic, microcode, etc.), software (e.g., instructions executing on a processing device), or a combination thereof. Input buffer 402 may store a subset of the input data of neural processor 218 as the subset of the input data is received from a source. The source may be data processor 318, planar engine 340, or another suitable component. Input buffer 402 may send an appropriate segment of input data for a current task or process loop to computation core 416 for processing. Input buffer 402 may include a shifter 410 that shifts read locations of input buffer 402 to change the segment of the input data sent to computation core 416. By changing segments of the input data provided to computation core 416 via shifting, neural engine 314 can perform multiply-accumulate for different segments of the input data based on a fewer number of read operations. In some embodiments, the input data of neural processor 218 includes data of difference convolution groups and/or input channels.

As described above, in some embodiments in which neural task manager 310 determines that the kernel coefficients are to be re-used for a task utilizing multiple layers and/or for multiple tasks of neural engines 314, kernel DMA engine 324 may retrieve the entire kernel matrix from system memory 230 and provide the kernel matrix to neural engine(s) 314. Neural engine(s) 314 may store the kernel matrix in a local memory (e.g., kernel memory 432).

Kernel determiner 434 may be implemented by processing logic that can include hardware (e.g., circuitry, dedicated logic, programmable logic, microcode, etc.), software (e.g., instructions executing on a processing device), or a combination thereof. Kernel determiner 434 may include a metadata buffer reader 440 that is configured to retrieve the metadata from input sparsity metadata buffer 358 (rather than metadata buffer reader 330) and determine, based on metadata 324, which kernel coefficients of the kernel matrix stored in kernel memory 432 are to be utilized for performing a task. For instance, kernel determiner 434 may analyze the metadata to determine which portion(s) (e.g., WUs) of the activation map generated by neural engine 314 included all zero values and which portion(s) of the activation map included at least one non-zero value based on the sparsity encoding utilized by the metadata, as described above. Kernel determiner 434 may be configured to retrieve a set of kernel coefficients mapped to the portion(s) including at least one non-zero value. Kernel determiner 434 retrieves the set of kernel coefficients from the kernel matrix stored in kernel memory 432. The retrieved kernel coefficients are provided to computation core 416, for example, to perform a convolution operation utilizing MAD circuits MAD0 through MADN.

It is noted that computation core 416 receives either the kernel coefficients from kernel DMA engine 324 or the kernel coefficients from kernel determiner 434 based on whether neural task manager 310 determines that kernel coefficients are to be re-used for a task utilizing multiple layers and/or for multiple tasks of neural engines 314. For instance, if neural task manager 310 determines that that kernel coefficients are to be re-used for a task utilizing multiple layers, for multiple tasks of neural engines 314, and/or for multiple WUs within the same task, neural task manager 310 may provide a first task command to kernel DMA engine 324 instructing it to retrieve the kernel matrix (in its entirety) from system memory 230 and store the kernel matrix in kernel memory 432. Neural task manager 310 may also provide a second task command to kernel determiner 434 instructing it to determine which kernel coefficients from the kernel matrix stored in kernel memory 432 are to be retrieved. For instance, neural task manager 310 may provide a task command to metadata buffer reader 440 to retrieve the metadata from input sparsity metadata buffer 358. Utilizing the metadata, kernel determiner 434 may determine which portions of the retrieved kernel matrix are to be skipped and which portions of the retrieved kernel matrix (e.g., the portions corresponding to non-zero portions of the activation map) are to be retrieved from the kernel matrix stored in kernel memory 432. Otherwise, neural task manager 310 provides a task command to metadata buffer reader 330 to retrieve the metadata from input sparsity metadata buffer 358 so that kernel DMA engine 324 can determine which kernel coefficients from the kernel matrix stored in source memory 230 are to be retrieved.

The kernel matrix stored in kernel memory 432 is re-used in multiple layers, for multiple tasks, and/or multiple WUs within the same task. Accordingly, by storing the kernel matrix in kernel memory 432, kernel coefficients of the kernel matrix are not repeatedly retrieved from system memory 230, thereby reducing the number of read operations to system memory 230.

Computation core 416 may be implemented by processing logic that can include hardware (e.g., circuitry, dedicated logic, programmable logic, microcode, etc.), software (e.g., instructions executing on a processing device), or a combination thereof. Computation core 416 may be configured to perform computation operations. For this purpose, computation core 416 may include MAD circuits MAD0 through MADN and a post-processor 428. Each of MAD circuits MAD0 through MADN may store an input value in the segment of the input data and a corresponding kernel coefficient from the kernel coefficients received from kernel DMA engine 324. The input value and the corresponding kernel coefficient are multiplied in each of MAD circuits MAD0 through MADN to generate a processed value.

Accumulator 414 may be implemented by processing logic that can include hardware (e.g., circuitry, dedicated logic, programmable logic, microcode, etc.), software (e.g., instructions executing on a processing device), or a combination thereof. Accumulator 414 may be configured to receive and store processed values from MAD circuits MAD0 through MADN. The processed values stored in accumulator 414 may be sent back as feedback information for further multiply and add operations at MAD circuits or sent to post-processor 428 for post-processing. Accumulator 414 in combination with MAD circuits form a multiply-accumulator (MAC) 404.

Post-processor 428 may be implemented by processing logic that can include hardware (e.g., circuitry, dedicated logic, programmable logic, microcode, etc.), software (e.g., instructions executing on a processing device), or a combination thereof. Post-processor 428 may be configured to further process values received from accumulator 414. Post-processor 428 may perform operations including applying linear functions (e.g., Rectified Linear Unit (ReLU)), normalized cross-correlation (NCC), merging the results of performing neural operations on 8-bit data into 16-bit data, and local response normalization (LRN). The result of such operations is output from post-processor 428 as processed values to outputter 424. In some embodiments, the processing at the post-processor 428 is bypassed. For example, the data in accumulator 414 may be sent directly to outputter 424 for access by other components of neural processor 218.

NE control 418 may be implemented by processing logic that can include hardware (e.g., circuitry, dedicated logic, programmable logic, microcode, etc.), software (e.g., instructions executing on a processing device), or a combination thereof. NE control 418 may be configured to control operations of other components of neural engine 314 based on the operation modes and parameters of neural processor 218. Depending on different modes of operation (e.g., group convolution mode or non-group convolution mode) or parameters (e.g., the number of input channels and the number of output channels), neural engine 314 may operate on different input data in different sequences, return different values from accumulator circuit 414 to MAD circuits, and perform different types of post-processing operations at post-processor 428. To configure components of neural engine 314 to operate in a desired manner, NE control 418 sends task commands that may be included in the feedback information to components of neural engine 314. NE control 418 may include a rasterizer 430 that tracks the current task or process loop being processed at neural engine 314.

Rasterizer 430 may be implemented by processing logic that can include hardware (e.g., circuitry, dedicated logic, programmable logic, microcode, etc.), software (e.g., instructions executing on a processing device), or a combination thereof. Rasterizer 430 may be configured to perform the operations associated with dividing the input data into smaller units (segments) and regulate the processing of the smaller units through the MACs 404 and accumulator 414. Rasterizer 430 may keep track of sizes and ranks of segments of the input/output data (e.g., groups, work units, input channels, output channels) and instructs the components of neural processor 218 for proper handling of the segments of the input data. For example, rasterizer 430 operates shifters 410 in input buffer 402 to forward the correct segments 408 of input data to MAC 404 and send the finished output data to buffer cache 334. Other components of neural processor 218 (e.g., kernel DMA engine 324, cache 334, planar engine 340) may also have their corresponding rasterizers to monitor the division of input data and the parallel computation of various segments of input data in different components.

Outputter 424 may be implemented by processing logic that can include hardware (e.g., circuitry, dedicated logic, programmable logic, microcode, etc.), software (e.g., instructions executing on a processing device), or a combination thereof. Outputter 424 may receive the processed values from post-processor 428 and interfaces with data processor 318 to store the processed values in data processor 318. For this purpose, outputter 424 may send out output data in a sequence or a format that is different from the sequence or format in which the processed values are processed in post-processor 428.

The components in neural engine 314 may be configured during a configuration period by NE control 418 and neural task manager 310. For this purpose, neural task manager 310 sends configuration information to neural engine 314 during the configuration period. The configurable parameters and modes may include mapping between input data elements and kernel elements, the number of input channels, the number of output channels, performing of output strides, and enabling/selection of post-processing operations at post-processor 428.

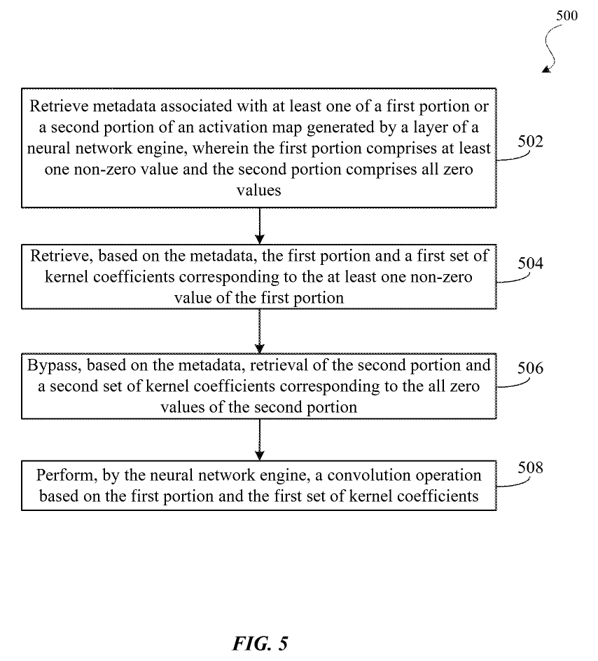

FIG. 5 is a flowchart for a method 500 for performing neural network operations based on sparse activations, according to some embodiments. Method 500 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 3. Method 500 is not limited to that example embodiment.

In 502, metadata buffer reader 330 and metadata buffer reader 360 may retrieve the metadata associated with at least one of a first portion or a second portion of an activation map generated by a layer of a neural network engine (e.g., neural engine(s) 314). The first portion (e.g., the sparse data) includes at least one non-zero value, and the second portion includes all zero values. In some embodiments, metadata buffer reader 330 may retrieve the metadata from a first data buffer (e.g., input sparsity metadata buffer 358). In some embodiments, the metadata may include at least one of a first indication indicating a size of the activation map, a second indication indicating that the second portion includes the all zero values, or a third indication indicating that the first portion includes the at least one non-zero value.

In 504, based on the metadata, source DMA engine 346 may retrieve the first portion of the activation map and kernel DMA engine 324 may retrieve a first set of kernel coefficients corresponding to the at least one non-zero value of the first portion. For example, source DMA engine 346 may retrieve the first portion (e.g., the sparse data) of the activation map from input sparse data buffer 338 and store the sparse data in cache 334. Neural engine(s) 314 may retrieve the sparse data from cache 334. Kernel DMA engine 324 may retrieve the first set of kernel coefficients from a kernel matrix stored in system memory 230 external to neural engine 314 (e.g., from kernel data buffer 362 of system memory 230).

In 506, based on the metadata, source DMA engine 346 may bypass retrieval of the second portion and kernel DMA engine 324 may bypass retrieval of a second set of kernel coefficients corresponding to the all zero values of the second portion.

In 508, the neural network engine (e.g., neural engine(s) 314) may perform a convolution operation based on the first portion and the first set of kernel coefficients.

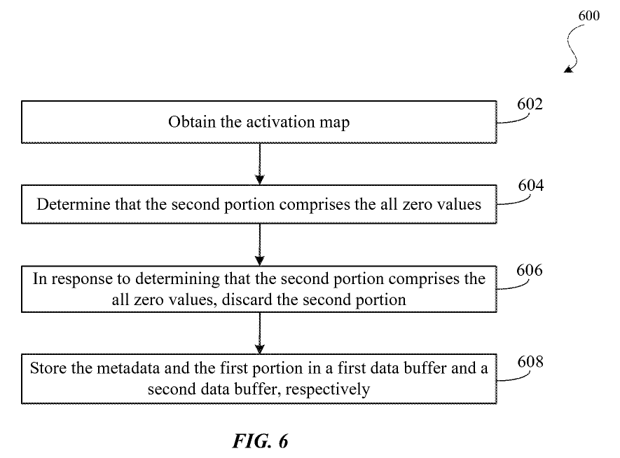

FIG. 6 is a flowchart for a method 600 for providing kernel coefficients to a network neural engine, according to some embodiments. Method 600 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art.

Method 600 shall be described with reference to FIG. 3. Method 600 is not limited to that example embodiment. It is noted that the steps of method 600 may occur prior to retrieving the metadata as described above with reference to step 502 of FIG. 5.

In 602, all-zero activation detector 348 may obtain the activation map.

In 604, all-zero activation detector 348 may determine that the second portion includes the all zero values.

In 606, in response to determining that the second portion includes the all zero values, all-zero activation detector 348 may discard the second portion. For example, all-zero activation detector 348 may not store the second portion in memory (e.g., system memory 230).

In 608, destination DMA engine 320 may store the metadata and the first portion (e.g., the sparse data) in a first data buffer (e.g., output sparsity metadata buffer 336) and a second data buffer (e.g., output sparse data buffer 356), respectively. For example, all-zero activation detector 348 may provide the metadata and the first portion to data processor 318, which temporarily stores the metadata and the first portion in cache 334. Destination DMA engine 320 may retrieve the metadata and the first portion from cache 334 and store the metadata in output sparsity metadata buffer 336 and store the first portion in output sparse data buffer 356. In some embodiments, output sparsity metadata buffer 336 and output sparse data buffer 356 are stored in system memory 230 external to the neural network engine (e.g., neural engine 314A).

In some embodiments, data processor 318 may provide, from output sparse data buffer 356, the first portion to another layer of the neural network engine (e.g., network engine 314A). For example, source DMA engine 346 may retrieve the first portion from output sparse data buffer 356 and provide the first portion to data processor 318, which temporarily stores the first portion in cache 334. Neural engine 314 may retrieve the first portion from cache 334 and provide the first portion to another layer thereof. Kernel coefficients may also be provided to the other layer of the neural network engine. The other layer of the neural network engine may be configured to perform an operation (e.g., a convolution operation) based on the first portion and the kernel coefficients.

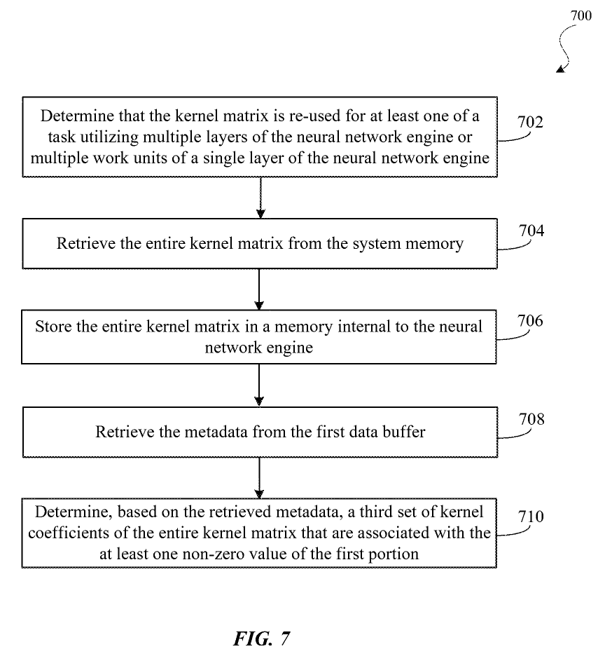

In certain scenarios, the kernel matrix may be stored into a memory local to a neural network engine if it is frequently used to perform operations. FIG. 7 is a flowchart for a method 700 for storing a kernel matrix into a memory local to a neural network engine, according to some embodiments. Method 700 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art.

Method 700 shall be described with reference to FIGS. 3 and 4. Method 700 is not limited to that example embodiment.

In 702, neural task manager 310 may determine that the kernel matrix is re-used for at least one of a task utilizing multiple layers of the neural network engine (e.g., neural engine 314A) or multiple WUs of a single layer of the neural network engine.

In 704, in response to determining that the kernel matrix is re-used for the at least one of the task utilizing multiple layers of the neural network engine or the multiple WUs of the single layer of the neural network engine, kernel DMA engine 324 may retrieve the entire kernel matrix from system memory 230 (e.g., from kernel data buffer 362).

In 706, kernel DMA engine 324 may store the entire kernel matrix in a memory (e.g., kernel memory 432) internal to the neural network engine (e.g., neural engine 314A).

In 708, metadata buffer reader 440 may retrieve the metadata from the first data buffer (e.g., input sparsity metadata buffer 358).

In 710, kernel determiner 434 may determine, based on the metadata, a third set of kernel coefficients of the entire kernel matrix that are associated with the at least one non-zero value of the first portion of the activation map. Kernel determiner 434 may perform such a determination for each iteration that the kernel matrix is re-used for a particular task. The determined set of kernel coefficients may be provided to computation core 416, for example, to perform a convolution operation utilizing MAD circuits MAD0 through MADN.

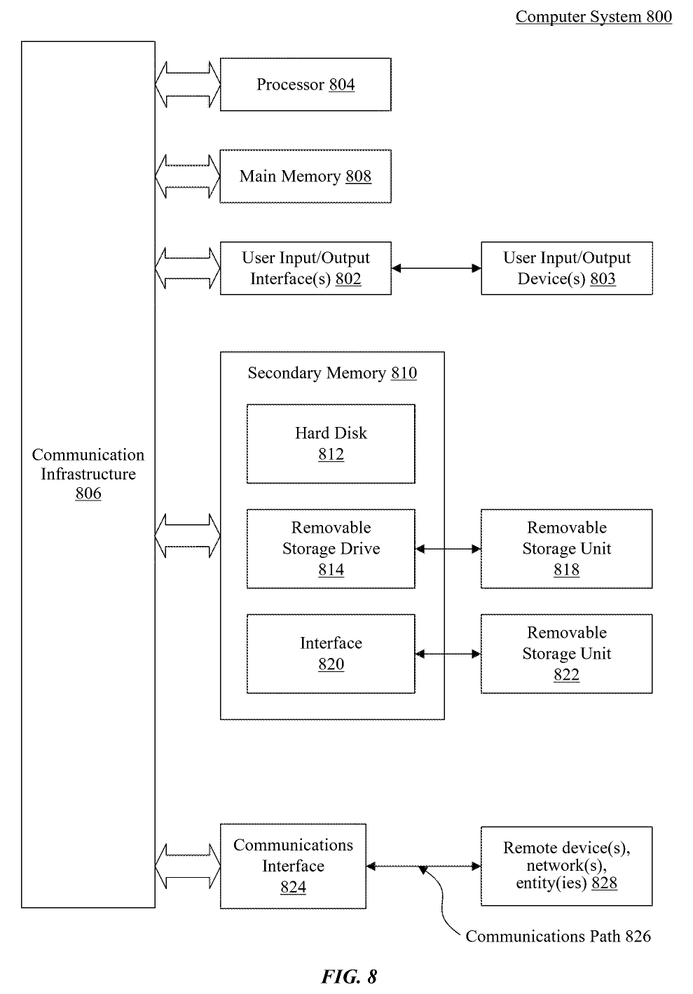

Various aspects can be implemented, for example, using one or more computer systems, such as computer system 800 shown in FIG. 8. Computer system 800 can be any computer capable of performing the functions described herein, such as the functions of device 100 of FIGS. 1 and 2 (and the components thereof) and the operations of FIGS. 5-7. Computer system 800 includes one or more processors (also called central processing units, or CPUs), such as a processor 804. Processor 804 is connected to a communication infrastructure 806 (e.g., a bus). Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/or any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

It is to be appreciated that the Detailed Description section, and not the Abstract of the Disclosure section, is intended to be used to interpret the claims. The Abstract of the Disclosure section may set forth one or more but not all possible aspects of the present disclosure as contemplated by the inventor(s), and thus, are not intended to limit the subjoined claims in any way.

Unless stated otherwise, the specific aspects are not intended to limit the scope of claims that are drafted based on this disclosure to the disclosed forms, even where only a single example is described with respect to a particular feature. The disclosed aspects are thus intended to be illustrative rather than restrictive, absent any statements to the contrary. The application is intended to cover such alternatives, modifications, and equivalents that would be apparent to a person skilled in the art having the benefit of this disclosure.

The foregoing disclosure outlines features of several aspects so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the aspects introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a system memory; and
a neural processor configured to:
retrieve metadata associated with an activation map of a neural network engine of the neural processor, wherein the activation map comprises non-zero values and zero values;
retrieve, based on the metadata, a first set of kernel coefficients corresponding to the non-zero values in the activation map;
bypass, based on the metadata, retrieval of a second set of kernel coefficients corresponding to the zero values in the activation map; and
perform, by the neural network engine, a convolution operation based on the non-zero values and the first set of kernel coefficients.

2. The system of claim 1, wherein the neural processor is further configured to:
obtain the activation map;
determine that the activation map comprises the zero values;
in response to a determination that the activation map comprises the zero values, discard the zero values; and
store the metadata and the non-zero values in a first data buffer and a second data buffer, respectively.

3. The system of claim 2, wherein, to retrieve the metadata, the neural processor is configured to:
retrieve the metadata from the first data buffer.

4. The system of claim 2, wherein the neural processor is further configured to:
provide, from the second data buffer, the non-zero values to a layer of the neural network engine.

5. The system of claim 2, wherein the first data buffer and the second data buffer are maintained in the system memory, and wherein the system memory is external to the neural network engine.

6. The system of claim 2, wherein, to retrieve the first set of kernel coefficients corresponding to the non-zero values, the neural processor is configured to:
retrieve the first set of kernel coefficients from a kernel matrix stored in a system memory external to the neural network engine.

7. The system of claim 6, wherein the neural processor is further configured to:
determine that the kernel matrix is re-used for at least one of a task utilizing multiple layers of the neural network engine or multiple work units of a single layer of the neural network engine; and
in response to a determination that the kernel matrix is re-used for at least one of the task utilizing the multiple layers of the neural network engine or the multiple work units of the single layer of the neural network engine:
retrieve the entire kernel matrix from the system memory;
store the entire kernel matrix in a memory internal to the neural network engine;
retrieve the metadata from the first data buffer; and
determine, based on the retrieved metadata, a third set of kernel coefficients of the entire kernel matrix that are associated with the non-zero values.

8. The system of claim 1, wherein the metadata comprises at least one of:
a first indication indicating a size of the activation map;
a second indication indicating portions of the activation map that comprise the zero values; or
a third indication indicating portions of the activation map that comprise the non-zero values.

9. A method, comprising:
retrieving metadata associated with at least one of a first portion or a second portion of an activation map generated by a layer of a neural network engine, wherein the first portion comprises at least one non-zero value and the second portion comprises all zero values;
retrieving, based on the metadata, the first portion and a first set of kernel coefficients corresponding to the at least one non-zero value of the first portion; bypassing, based on the metadata, retrieval of the second portion and a second set of kernel coefficients corresponding to the all zero values of the second portion; and
performing, by the neural network engine, a convolution operation based on the first portion and the first set of kernel coefficients.

10. The method of claim 9, further comprising:
obtaining the activation map;
determining that the second portion comprises the all zero values;
in response to determining that the second portion comprises the all zero values, discarding the second portion; and
storing the metadata and the first portion in a first data buffer and a second data buffer, respectively.

11. The method of claim 10, wherein retrieving the metadata comprises retrieving the metadata from the first data buffer.

12. The method of claim 10, further comprising:
providing, from the second data buffer, the first portion to another layer of the neural network engine.

13. The method of claim 10, wherein the first data buffer and the second data buffer are maintained in a system memory external to the neural network engine.

14. The method of claim 10, wherein retrieving the first portion and the first set of kernel coefficients corresponding to the at least one non-zero value of the first portion comprises retrieving the first portion from the second data buffer and retrieving the first set of kernel coefficients from a kernel matrix stored in a system memory external to the neural network engine.

15. The method of claim 14, further comprising:
determining that the kernel matrix is re-used for at least one of a task utilizing multiple layers of the neural network engine or multiple work units of a single layer of the neural network engine; and
in response to determining that the kernel matrix is re-used for at least one of the task utilizing the multiple layers of the neural network engine or the multiple work units of the single layer of the neural network engine:
retrieving the entire kernel matrix from the system memory; storing the entire kernel matrix in a memory internal to the neural network engine; retrieving the metadata from the first data buffer; and
determining, based on the retrieved metadata, a third set of kernel coefficients of the entire kernel matrix that are associated with the at least one non-zero value of the first portion.

16. The method of claim 9, wherein the metadata comprises at least one of:
a first indication indicating a size of the activation map;
a second indication indicating that the second portion comprises all zero values; or
a third indication indicating that the first portion comprises the at least one non-zero value.

17. A non-transitory computer readable medium having instructions stored thereon that, when executed by at least one processor, cause the at least one processor to perform operations comprising:
retrieving metadata associated with at least one of a first portion or a second portion of an activation map generated by a layer of a neural network engine, wherein the first portion comprises at least one non-zero value and the second portion comprises all zero values;
retrieving, based on the metadata, the first portion and a first set of kernel coefficients corresponding to the at least one non-zero value of the first portion; bypassing, based on the metadata, retrieval of at least one of the second portion or a second set of kernel coefficients corresponding to the all zero values of the second portion; and
performing, by the neural network engine, a convolution operation based on the first portion and the first set of kernel coefficients.

18. The non-transitory computer readable medium of claim 17, the operations further comprising:
obtaining the activation map;
determining that the second portion comprises all zero values;
in response to determining that the second portion comprises all zero values, discarding the second portion; and
storing the metadata and the first portion in a first data buffer and a second data buffer, respectively.

19. The non-transitory computer readable medium of claim 18, wherein retrieving the metadata comprises retrieving the metadata from the first data buffer.

20. The non-transitory computer readable medium of claim 18, the operations further comprising:
providing, from the second data buffer, the first portion to another layer of the neural network engine.
